(19) United States
(12) Patent Application Publication
(10) Pub. No.: US 2025/0348829 A1
(43) Pub. Date: Nov. 13, 2025

(54) TRACKING AND RECORDING TRANSACTIONS OF DIGITAL ASSETS WITH PHYSICAL ASSOCIATION

(71) Applicant: Ali Vazirizadeh, Mississauga (CA)

(72) Inventor: Ali Vazirizadeh, Mississauga (CA)

(73) Assignee: AISIMPRO INC., Mississauga (CA)

(21) Appl. No.: 18/909,980

(22) Filed: Oct. 9, 2024

Related U.S. Application Data
(60) Provisional application No. 63/543,703, filed on Oct. 11, 2023.

(51) Int. Cl. G06Q 10/08; H04L 9/00

(52) U.S. Cl. CPC G06Q 10/08; H04L 9/50; H04L 2209/56

(57) ABSTRACT

The present disclosure relates to the field of supply chain management and traceability through a commodity value chain. More specifically, the disclosure pertains to systems that track and record transactions of digital assets associated with physical commodities, recycling materials or goods using blockchain technology.

### CROSS REFERENCE

This application claims priority to the U.S. provisional application No. 63/543,703 titled: TRACKING AND RECORDING TRANSACTIONS OF DIGITAL ASSETS WITH PHYSICAL ASSOCIATION″, filed Oct. 11, 2023, the content of which is incorporated by reference in its entirety.

### TECHNICAL FIELD

The present disclosure relates to the field of supply chain management and traceability through a commodity value chain. More specifically, the disclosure pertains to systems that track and record transactions of digital assets associated with physical commodities, recycling materials or goods using blockchain technology.

This system enables transparency, traceability, and accountability throughout the supply chain. A summarized explanation of the invention is provided below, accompanied by illustrative diagrams:

### BACKGROUND

Traditional supply chain systems often lack transparency, making it difficult to trace the origin and journey of products. This can lead to inefficiencies, fraud, and difficulties in verifying the authenticity and conditions under which goods are produced or transferred. In these systems, traceability is achieved by using physical identifiers, segregation, documentation, and mass balancing to track items across enterprises and process flows.

U.S. Pat. No. 9,852,393 discloses a method and system for managing a chain of custody for cannabis, from seeds to end-user products like edibles. Each stage across the cannabis supply chain (from raw material to the finished product) includes adding a certain physical tag adhered (i.e. sprayed) to the input of that stage and the tags from each stage are accumulated along the supply chain. These tags, along with their associated information are stored in a database. This ultimately enables tracing a defective edible product back to its origin, such as a defective plant material. However, the manual process of tagging across the supply chain's stages (e.g., by spraying the tag material) can introduce human errors, affecting accurate traceability.

To achieve traceability in product supply chains, some companies mandate standardized product identification codes for their suppliers so that they can trace a product back to its origin (in case of defects, for example), but this isn't always the case. Companies interested in tracing product origins and transformations often need to collaborate to establish traceability systems. These systems monitor materials, parts, and supplies throughout production, processing, packaging, and shipping. Sometimes, third-party tracking software is employed to connect supplies between companies, even though some information might be confidential. For example, U.S. Pat. No. 9,436,923 B1, introduces a method for generating private/public keys for product SKUs (Stock Keeping Unit). However, managing keys for each SKU can be challenging, especially for consumer goods in an industry ecosystem.

With the emergence of blockchain technology the problem of human errors in supply chain management and traceability is greatly improved. In this sense, the blockchain technology facilitates traceability by providing a transparent and immutable record-keeping system. It ensures that every step in the supply chain is documented and verifiable, from the origin of raw materials to the final product's delivery. In other words, it creates a trustworthy and transparent system where participants can confidently track the journey of goods and verify their authenticity at every step. This can lead to improved efficiency, reduced fraud, and better overall management of the supply chain. Consequently, each raw material, intermediate product, by-product, and finished product across the supply chain is associated with a distinct digital asset. These digital assets store relevant information on blockchain allowing for precise traceability such as pinpointing a defective finished product's origin of the problem.

U.S. Pat. No. 11,461,775 discloses a system and method for tracking the provenance and flows of goods, services, and payments in responsible supply chains. In order to augment blockchain's native traceability, an additional solution is proposed. This additional solution is based on providing unique transform transactions that record the identifiers of one or more inputs to a transformation process. The transformation process may be an aggregation or disaggregation of materials, a loss or tolerance factor, and record one or more unique identifiers of the outputs. As can be appreciated by the person skilled in the art, the identifiers are assigned solely to the input and/or outputs of the transformation process and no identifier is assigned to the transformation process itself (i.e. process specifications). for instance, a powdered product that is distributed and purchased by a customer, may be associated with limited data such as its lot number or production date that enables tracing the product to its origin. However, the described method lacks information related to the product manufacturing process including the amount of water and energy used to produce the product. Another shortcoming of this disclosure is the lack of a “fungible” scheme in assigning identifiers to inputs or outputs of a process. In other words, the disclosure does not foresee a possibility of mixing or merging or interchangeably swapping the identifiers that contain substantially identical information.

Nathan Williams in the article titled “Protocol for Due Diligence in the Raw Material Supply Chain” proposes an open source, interoperable blockchain protocol for raw material supply chain integrity. The article notes “fungible nature of raw materials” as a key issue with the scalability and applicability on an industry-wide scale meaning that raw materials from different sources that have substantially identical properties could be mixed to allow scaling a process to an industrial level. According to the article, for any protocol to be useful to the industry, it will need to be functional even when adopted by only a portion of industry players, and account for the possibility of registered shipments being mixed with shipments that are not part of the system. To this end, the article proposes a mass balance approach to address this need. However, the mass balance approach proposed by the article is not an accurate representation of a true mass balance as it fails to account for all the inputs and discards those inputs that are from non-certified sources.

US20180232731A1 discloses a supply chain recording method with traceable function by implementing a blockchain-based system to enhance supply chain traceability and transparency. The transactions across the supply chain are securely recorded on the blockchain. Access to the transaction records is restricted to only issuers or receivers of transactions. Although this method enables monitoring of the transactions for the products or goods in the supply chain. However, it overlooks the process specifications across supply chains making certain steps non-traceable.

In view of the above, there is a need for systems and methods that allow traceability not only on inputs/outputs of successive processes across a supply chain but also on each and every one of the successive processes that receive the inputs and transform them as respective outputs. Such system and method could take advantage of the benefits of blockchain technology as stated above.

### SUMMARY

This Summary is provided to introduce a selection of concepts in a simplified form that are further described below in the Detailed Description. This Summary is not intended to identify key or essential aspects of the claimed subject matter.

This description relates to a system and method for tracking and recording transactions of digital assets associated with physical commodities, recycling materials, or goods leveraging blockchain technology.

All features of exemplary embodiments which are described in this disclosure and are not mutually exclusive can be combined with one another. Elements of one embodiment can be utilized in the other embodiments without further mention. Other aspects and features of the present invention will become apparent to those skilled in the art upon review of the following description of specific embodiments in conjunction with the accompanying Figures.

### BRIEF DESCRIPTION OF THE DRAWINGS

A detailed description of specific exemplary embodiments is provided herein below with reference to the accompanying drawings in which:

FIGS. 1A and 1B are non-limiting block diagrams of a supply chain comprising a process of converting one or more raw material streams into one or more products each of the raw materials and the products representing a digital asset in accordance with an embodiment of the present disclosure.

FIG. 2 is a non-limiting example of a process flow diagram of a supply chain starting with raw materials and ending to distributers in accordance with an embodiment of the present disclosure.

FIG. 3 is a non-limiting example of implementing a permissioned blockchain network for all the nodes involved in a supply chain in accordance with an embodiment of the present disclosure.

FIG. 4 is a flowchart corresponding to the supply chain of FIG. 2 in accordance with an embodiment of the present disclosure.

In the drawings, exemplary embodiments are illustrated by way of example. It is to be expressly understood that the description and drawings are only for the purpose of illustrating certain embodiments and are an aid for understanding. They are not intended to be a definition of the limits of the invention.

### DETAILED DESCRIPTION

The present technology is explained in greater detail below. This description is not intended to be a detailed catalog of all the different ways in which the technology may be implemented or all the features that may be added to the instant technology. For example, features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art considering the instant disclosure which variations and additions do not depart from the present technology. Hence, the following description is intended to illustrate some embodiments of the technology, and not to exhaustively specify all permutations, combinations, and variations thereof.

The present inventors have designed and developed a system and method according to the present disclosure for tracking and recording transactions of digital assets associated with physical commodities, goods and recycling materials using blockchain technology and cryptographic techniques. This system enables transparency, traceability, and accountability throughout the supply chain. The present disclosure outlines a system and method that enables tracking the origin and journey of commodities or goods across the supply chain. In addition, it allows an additional layer of transparency and traceability by enabling tracking of the product process specifications.

Moreover, the system and method enable a “fungible” scheme in assigning identifiers to inputs or outputs of a process meaning that allows mixing, merging, and interchangeably swapping the identifiers with substantially identical information. For example, in case of a steel making company (as a process), it is possible to have multiple inputs (i.e., multiple iron ore streams from different origins) each being assigned to an identifier. However, if the properties of these input streams are substantially identical (i.e., the iron ores have substantially equal purity levels), it would be possible to mix, merge or interchangeably swap these identifiers without affecting traceability across the whole supply chain.

### Definitions

Unless otherwise defined, all technical and scientific terms used herein have the same meaning as commonly understood by a person of ordinary skill in the art to which the present invention pertains. As used herein, and unless stated otherwise or required otherwise by context, each of the following terms shall have the definition set forth below.

As used herein, the terms digital asset refers to digital data associated with (e.g., owned by or belonging to) a user account. In particular, a digital asset can refer to a resource that is owned by a user account and generated from a module defining a class of digital assets. For example, a digital asset can include a title representing ownership of a physical asset or another digital asset, or one or more units of a digital currency or a fraction of a unit of digital currency. In the context of the present disclosure the term token can also be used interchangeably with digital asset.

As used herein, the term “blockchain” means a distributed database system comprising a continuously-growing list of ordered records (“blocks”) shared across a network. In a typical embodiment, the blockchain functions as a shared transaction ledger.

As used herein, the term “blockchain network” means the collection of nodes interacting via a particular blockchain protocol and rule set. A blockchain network also uses a software module called a smart contract (also referred to as chaincode within Fabric), that allows for controlling access to the distributed ledger, automating processes, controlling aspects of transactions, and executing certain actions if defined conditions are met. Changes or transactions that take place within the network are ratified or rejected via consensus between all the members of a network. Once ratified, a transaction is then recorded to the ledger. Data or transactions occurring within the network and entered into the ledger get encrypted, stored into a block, and then become non-modifiable (or immutable).

As used herein, the term “block” means a record in a continuously-growing list of ordered records that comprise a blockchain. In a typical embodiment, a block comprises a collection of confirmed and validated transactions, plus a nonce.

As used herein, the term “Hyperledger Fabric” is a private blockchain framework and is one of many projects within the Hyperledger blockchain platform. The framework is used as a foundation from which to develop blockchain-based applications, networks, and more. Fabric (as it is often shortened to) was designed for creating private blockchains that can be used within a single organization or group of aligned organizations that link to other blockchain implementations. Fabric prioritizes several key features as part of its architecture such as privacy, channels, scalability and modularity.

As stated above, the developed system contains an extra layer of traceability feature for tracking the products' production process across the supply chain. A non-limiting example of process specifications could be the Environmental, Social, and Governance (ESG) indicator of the production process by which certain products have been made across the supply chain. By incorporating these specifications into the digital assets associated with commodities or goods, the system enables participants to access vital information about the sustainability and ethical aspects of the production process. This transparency motivates the use of recycled materials by providing stakeholders with insights about products' eco-friendliness. As a result, the invention not only enhances traceability but also empowers consumers and other stakeholders to make informed decisions based on ethical and environmental considerations.

In a supply chain where multiple processes exist throughout the transformation of raw material into finished product, each transformation process may have certain specifications that could have its own identifier for traceability. Examples may include building product A and building product B where each of these products originate from same raw materials but processed by a less green intermediate process A and a more green intermediate process B, respectively (by green it is meant a process that creates lower greenhouse gas emissions). In this example, process A and process B can have their own respective identifiers that can add up the corresponding identifiers in building product A and building product B, respectively.

Moreover, the system and method according to the present disclosure go beyond simple asset tracking that involves digital assets containing detailed information such as specifications, timestamps, and more. Additionally, the system and method according to the present disclosure also accounts for the entire life cycle of commodities or goods, considering the diverse sources, processes, and attributes involved.

Finally, the system and method according to the present disclosure allows for traceability of digital assets on the basis of a true mass balance across the supply chain. This will be further explained in the subsequent sections.

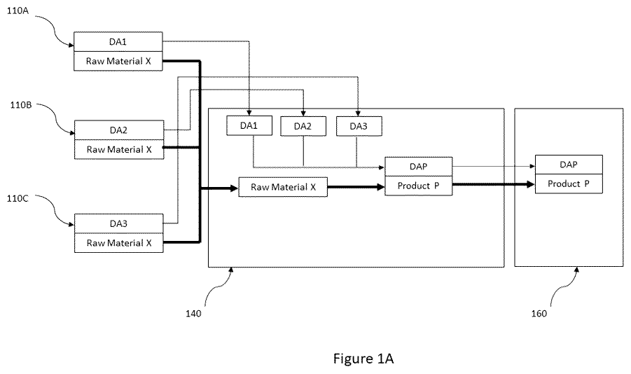

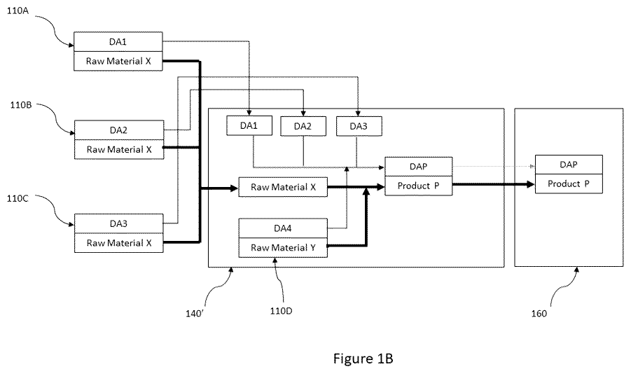

FIG. 1A is a non-limiting example of a block flow diagram showing a supply chain that starts with raw materials and ends with the product that is distributed by the distributors. In this example, raw material X from three different sources 110A, 110B and 110C is sent to process 140 for being processed.

Raw material X could be used in various manufacturing processes requiring traceability. For example:

In metallurgical industry, raw material X can be iron ore from different sources (e.g., different mines) that flows toward steel making process.

In cannabis industry, raw material X can be cannabis plant material from different sources (e.g., different growers).

In polymer and plastic recycling industry, raw material X can be polystyrene foam from different sources (e.g. different supermarkets and/or restaurants).

In oil and gas industry, raw material X can be crude oil from different sources (e.g. onshore oil, offshore oil, tight oil (shale oil), oil sands)

In precious metals industry, raw materials X can be gold from different sources/processes, (e.g. a conventional gold source, refractory gold, heap leach gold or gold as a byproduct of other commodities).

It would be apparent to the person skilled in the art that the examples made above are not intended to be limiting and the block diagram in FIG. 1A could be applicable to any supply chain that starts with an initial material and/or commodity and ends with a final material and/or commodity by going through one or more processes.

Further, in the context of this application, the blockchain's peer nodes are allocated to various stakeholders along the supply chain, specifically those engaged in receiving or dispatching goods, commodities, or raw materials. For instance, distinct nodes will be designated to raw material sources 110A-C, to the process that intakes these raw materials, and to phase 160 that follows the process and manages product P.

Referring to FIG. 1A, within the framework of digitizing processes digitization and ensuring traceability In a supply chain using blockchain, each stream of the raw material X from sources 110A, 110B and 110C has an associated digital asset (DA) that represents it. Specifically, raw material X from source 110A is represented by DA1, raw material X from source 110B is represented by DA2, and raw material X from source 110C is represented by DA3. These digital assets serves as identifiers for commodities, goods, raw materials, etc., containing information about them. The digital assets are created based on authority protocols and are created at each node along the supply chain by one or more electronic devices designated for that node.

In one preferred embodiment, the blockchain framework according to the present disclosure is Hyperledger Fabric.

It can be appreciated that depicting only three sources of raw material X is purely for illustration. In actual implementation, there might be more or fewer streams of raw material X in a supply chain. Each of the digital assets DA1, DA2 and DA3 contain information regarding raw material X and its corresponding source. Non-limiting examples of such information are raw material's origin, purity, physical and/or chemical properties, expiry date, etc. Other examples may be contemplated by the person skilled in the art without departing from the essence of the invention.

Once the raw material X stream from sources 110A, 110B and 110C enter the process 140, the process 140 converts raw material X into product P.

In one embodiment, the process 140 may be a simple mixing process in which raw material X from different sources are mixed together in a specific ratio resulting in product P.

In another embodiment, the process 140 may be a more complex process that involves changes in physical and/or chemical properties of raw material X from different sources and results in product P.

Within the process 140, the information corresponding to DA1, DA2, and DA3 is aggregated and consolidated into DAP which is a new digital asset related to the product from process 140 (as shown by thin arrows). Concurrently, the physical raw material from sources 110A, 110B, and 110C are combined within the process (as shown by thick arrows) to produce product P.

The inventors have developed a system and corresponding method of implementing such system in which the digital asset corresponding to the product, DAP, further includes information of the process by which said product has been produced.

Non-limiting examples of process information contained within DAP may be:

Example 1: the amount of fresh water consumed in a process: such information included in the DAP information, may prove useful as it may provide a comparative basis between the product offered in a specific supply chain and similar products provided within other supply chains. Moreover, by enabling traceability in the supply chain, the product can be linked to the amount of fresh water consumed per unit mass of product P (as well as other process specifications) anywhere across the supply chain.

Example 2: the amount of greenhouse gases (GHG) produced in a process: such information included in the DAP information, may prove useful as it may provide a comparative basis between the product offered in a specific supply chain and similar products provided within other supply chains. Moreover, by enabling traceability in the supply chain, the product can be linked to the amount of GHG produced per unit mass of product P (as well as other process specifications) anywhere across the supply chain.

Example 3: the amount of waste produced in a process: such information included in the DAP information, may prove useful as it may provide a comparative basis between the product offered in a specific supply chain and similar products provided within other supply chains. Moreover, by enabling traceability in the supply chain, the product can be linked to the amount of waste produced per unit mass of product P (as well as other process specifications) anywhere across the supply chain.

Example 4: the amount of energy consumed in a process: such information included in the DAP information, may prove useful as it may provide a comparative basis between the product offered in a specific supply chain and similar products provided within other supply chains. Moreover, by enabling traceability in the supply chain, the product can be linked to the energy consumed per unit mass of product P (as well as other process specifications) anywhere across the supply chain.

It would be apparent to the person skilled in the art that the examples set forth above are not intended to be limiting and other process specifications can be included in the information associated to DAP.

The product P as the output of process 140, may further proceed into the distribution phase 160. As can be expected, the product specifications remain constant through this phase and therefore, the information contained in the digital asset corresponding to product P, DAP, remains unaltered although the product may be packaged or contained in different ways for distribution. It is also noteworthy that the ownership of a digital asset may change as it moves through distribution channels.

As could be seen in FIG. 1A, the raw materials into the process 140 are of the same nature (raw material X) but from different sources.

FIG. 1B is a variant of FIG. 1A showing a supply chain that starts with raw materials X and Y and end with the product that is distributed by the distributors. In this example, raw material X from three different sources 110A, 110B and 110C is sent to process 140′ for being processed along with raw material Y which can be regarded as another digital asset (DA4). For the sake of simplicity, raw material Y in FIG. 1B is only from one source. However, it would be completely understandable by the person skilled in the art that there could be more than two types of raw materials and each could be from one or multiple sources without departing from the essence of the invention contemplated by the inventors.

By way of examples, raw materials X and Y can be raw materials for any process that needs to be tracked for traceability purpose. For example:

In metallurgical industry, raw materials X and Y can be different metals from different sources (e.g., different mines) that converge in an alloying process to produce an alloy.

In food industry, raw materials X and Y can be ingredients from different sources (e.g., different suppliers) intended to be combined to formulate a premix.

In chemical industry, raw materials X and Y can be base material and additive from different sources that will be combined.

Once the raw material X stream from sources 110A, 110B and 110C and raw material Y enter the process 140′, the process 140′ processes raw materials X and Y and converts them into product P.

In one embodiment, the process 140′ may be a simple mixing process in which raw materials X and Y from different sources are mixed together in a specific ratio resulting in product P.

In another embodiment, the process 140′ may be a more complex process that involves changes in physical and/or chemical properties of raw materials X and Y and results in product P.

Once into the process 140′, the information corresponding to DA1, DA2, DA3 and DA4 may be combined and merged into DAP which is a new digital asset related to the product from process 140′ (as shown by thin arrows). The raw material X from different sources 110A, 110B and 110C and raw material Y from source 110D are also combined in the process (as shown by thick arrows) to produce product P.

Similar to the description of FIG. 1A, the digital asset corresponding to the product, i.e. DAP, includes information on the process by which said product has been produced.

The product P as the output of process 140′, may further proceed into the distribution phase 160. Similarly, and as can be expected, the product nature would not change in this phase and therefore, the information contained in the digital asset corresponding to product P, DAP, would also remain unaltered although the product may be packaged or contained in different ways for distribution.

Regarding both FIGS. 1A and 1B, the digital assets associated to any of the raw materials X and/or Y may be created by one or more electronic devices to be verified by the organizations' peer nodes.

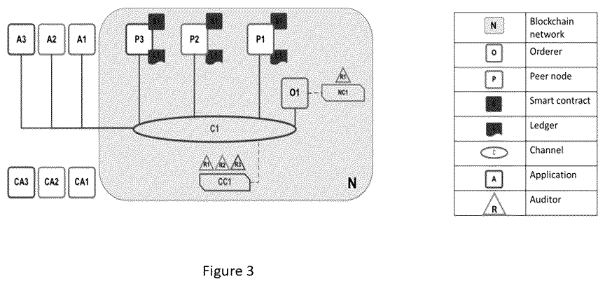

The corresponding device automatically logs every transfer and receipt activity (associated with a node input or output) as transactions. These transactions initiated by the users may be further validated and added to the blockchain N distributed ledger through relevant peer nodes with refer to FIG. 3. In addition, the one or more electronic devices will be assigned with a plurality of private keys respectively. A user who owns one of the private keys is capable of accessing one of the electronic devices 01 to check or track all of the transactions and relevant transferred information within the electronic device 01. The transactions will be assigned with a plurality of public keys respectively. The public keys are derived in accordance with the private key.

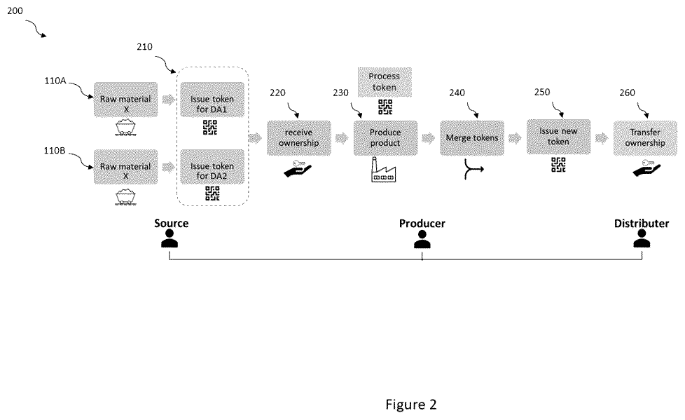

FIG. 2 is a representation of the system 200 according to the present invention. The system in FIG. 2, for the sake of simplicity, only comprises two streams of raw material X from different sources 110A and 110B while in fact, one stream of raw material or more than two streams of raw materials (similar or different raw materials) are also possible without departing from the essence of the invention. The depicted system includes 3 nodes: source (that supplies the raw materials), producer (which receives the raw materials from the producer node and processes the raw materials to result in product P) and distributor (which receives product P for distribution).

As can be seen from FIG. 2, for each stream of raw material X (regardless of its source whether 110A or 110B), a digital asset is created that would include all the information associated with the raw material which described above.

Once the raw materials X flow into the process 1, they are no longer owned by their respective source and now they are owned by the process or producer and treats them. Therefore, at point 220 an ownership transfer occurs which is again recorded stored as a transaction on the respective tokens.

Again, upon being processed in the process 140 at the producers location, the system issues a new token for product P that not only merges the tokens from 210 but also adds a process token that was created at step 230 and issues a new token at step 250.

The product P which is now ready for distribution by the distributors would no longer be owned by the producer and therefore, a new ownership transfer occurs at step 260 (a new transaction) which is accounted for the product token.

Referring to FIG. 3, an architecture of the blockchain network (N) that is implemented for a given supply chain is illustrated. The FIG. 3 demonstrates how various applications are interconnected with respective peer nodes using specific smart contracts and ledgers via a blockchain network (N). Each of A1-A3 represent an application for users to interact and update or query the ledger's data. For example, A1 may be used by raw material supplier end users, A2 may be used by the producer's end users, and A3 may be used by the distributor or buyer end users. Each of the applications A1-A3 is mapped to a respective peer node P1-P3 (i.e., A1->P1, A2->P2 and A3->P3) Within the blockchain network (N) wherein the peer nodes have their respective smart contracts S1-S3 along with a copy of the ledger L. The applications A1-A3 may communicate in a private channel (C1) within the blockchain network which is owned and administered by entities R1-R3 representing the raw material supplier, producer, and distributor, respectively. In this arrangement, the orderer plays a pivotal role in sequencing transactions.

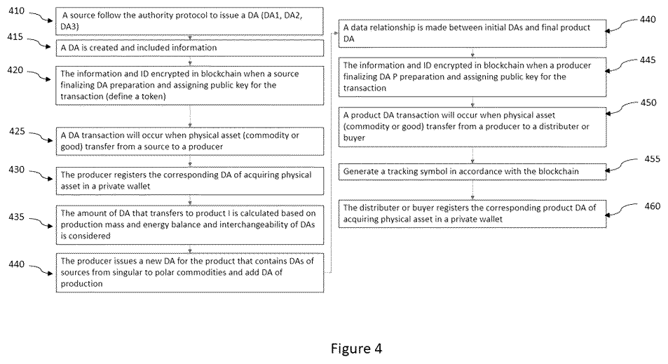

With reference to FIG. 4, a method corresponding to the system in FIGS. 1A-2 is disclosed. In step 410, a plurality of assets are issued with regards to authority protocols in source units released from a plurality of sources to one of a plurality of producers as a plurality of transactions. When the source sells any goods or assets or commodity or a recycle materials to a producer, the source will be the issuer to use the electronic devices to transfer the digital assets representing the goods or commodity or a recycle materials to one producer. The act for each of the issuers to transfer one of the digital assets to the receiver is called the transaction.

Specifically, each of the goods or commodities from each of the sources will be assigned one of the digital assets. At step 415 a digital Asset of source includes commodity spec, process spec, production timestamp, description, and other relevant information including ESG index, company ranking, story, etc. The codes/numbers/identifiers representing the digital assets of the source will be encrypted by the hash algorithm. When the producer acquires one of the digital assets from one of the sources, the producer will receive the corresponding digital asset.

These principles address the confidentiality and transparency of data for participants as follows: 1—Upon participation in a transaction, participants gain access to the complete supply chain history of the asset. 2—Participants have visibility into upstream supply chain information, but their access to downstream information is restricted once the asset is sold. 3—Participants are only able to view data from other participants if those participants are positioned upstream in the supply chain. 4—Non-participants lack access to any supply chain data stored on the blockchain unless they possess the corresponding key. 5—Certain information can be made accessible to everyone through scanning a barcode, serial number or other identifiers of an asset. This information is determined according to protocols established by stakeholders.

In step 420, the transactions for the digital assets of source released from the source to one of the producers will be digitally signed by the user's public key from the source organization and the ownership will be transferred to the producer. The public keys are generated and derived from the private key of the electronic device of the receiver. The encryption and decryption of the public key and the private key implement a public key cryptography called the RSA algorithm and Elliptic Curve Digital Signature Algorithm (ECDSA). RSA algorithm and ECDSA are well known for a person with ordinary skill in the information security field, and the detail thereof is omitted herein. In the present method, only the receiver with the private key can implement the electronic device to see the encrypted information in the transaction, but the public key can be seen by everyone.

In step 425, digital assets, encompassing the asset's information, are issued and digitally signed using the supplier's private key. While the physical asset is dispatched to the producer, its corresponding digital asset is transmitted to the public key associated with the producer set to receive the asset. Upon receiving of the physical asset, a confirmation receipt will be signed and forwarded to the relative peer nodes for validation before being added to blockchain.

In step 430, upon receiving the digital asset, the producer can access the asset's information using their private key, stored in the user's wallet containing their identity key.

In step 435, The producer receives several digital assets of the same commodity or different commodities that are used to produce product P with reference to FIG. 1. The amount of digital asset issued by sources that transfer to product P is calculated based on production mass and energy balance. The digital assets from the same commodity are fungible and the same commodity from different sources can be mixed or exchanged while the final product quality does not change. In the mass balancing the commodity lost during the production process are considered.

In step 440, The producer issues a new digital asset for the product that contains digital assets of sources from singular to plural commodities and adds digital asset P with reference to FIG. 1 which includes, product spec, process spec, production timestamp, description and other relevant information including ESG index, company ranking, story and etc.

For example, a producer acquires iron ore with an iron content ranging from 60% to 65% from various sources. These iron ores are combined in a stockpile and then fed into the plant to create slabs. The resulting slabs possess a 100% iron composition. Subsequently, the digital assets corresponding to the iron ores will be utilized to issue a digital asset for the slab. The calculation of the digital asset's value is rooted in the iron ore mass balance, irrespective of the specific source of the iron ore or the individual contribution of each received iron ore to the final product. Furthermore, the mass balance model calculates the amount of iron lost in the slag in order to respect metal accounting. This grants the producer the flexibility to select any registered digital asset from their private wallet to generate new digital assets for the slab, as long as the chosen digital asset's value does not surpass the available registered amount of that digital asset in accordance with the mass balance.

At step 445, the blocks are saved and encrypted with a plurality of the public keys in a blockchain. If any transactions occur during a period of time, the blocks representing the transactions with the first digital signatures will be saved and encrypted with the public keys by the hash algorithm. In order to secure and save all of the transactions occurring during the period of time, the blocks representing the transactions will be recorded and encrypted cyclically, such as every ten minutes.

After the transactions between the source and the producer are finished, the producer may become a new one of the source for value chain downstream units. All of the aforementioned steps will be repeated again to perform other transactions. For example, the slab made by one of the producers will be sold to a flat steel producer. The slabs producer becomes one of the sources and the consumer is another one of the producers. After the flat steel producer purchases the slabs, a new digital asset is transmitted to the next buyer (the consumer).

Further in step 445, the block in step 420 will be written in the blockchain. The blockchain in the present method will check whether any one of the transactions occurs during one period of time, such as 5 minutes or 10 minutes. When the blockchain realizes that one of the transactions has occurred during the period of time, the block associated with the digital signature (such as the first digital signatures or the one of the second digital signature) that may include but not be limited to commodity spec, process spec, production timestamp, description, and other relevant information including ESG index, company ranking, story, etc. will be written into the blockchain.

Moreover, the hash value (e.g. the digital asset's identifier) of the distributed ledger is available on the internet for the sellers and the buyers. However, not every one of the electronic devices is capable of seeing all of the transactions within the distributed ledger. Only the electronic device with the private key may see the transactions performed by the electronic device.

In step 450, a digital asset transaction takes place concurrent with the transfer of a physical asset (commodity or good) between parties. It's important to note that these digital transactions align with and support the material transfer activities and are not contingent on any predefined conditions.

For example, consider an iron ore mine that employs advanced technology to lower energy consumption per ton of production. This mine issues a process specification that encompasses the Environmental, Social, and Governance (ESG) index of the iron ore and the ESG index of the company itself. Additionally, the mine openly shares its commitment to enhancing the well-being of remote communities. These details, coupled with a unique mine ID, timestamp, geographical location, and comprehensive specifications related to the quantity and quality of the product, are collectively registered using a smart contract within a blockchain. This amalgamation results in the creation of a source digital asset.

Subsequently, this digital asset is transferred to an iron-making plant, where the process of producing slabs takes place. Within the plant's operation, the initial iron ore is blended with other iron ore, as previously described, leading to the production of slabs and wasted materials such as slag. As the plant functions as the producer, it generates a new digital asset for the slabs. This new digital asset encompasses the existing digital assets from the source (as outlined earlier), augmented by the slab process specifications, production timestamp, descriptive information, and other pertinent details including ESG index, company ranking, and a narrative akin to what the source had issued.

Ultimately, this final digital asset is transmitted either to a distributor or directly to the end consumer. The comprehensive digital record encapsulates the journey of the product from its origin at the mine through its transformation in the plant, thereby allowing all relevant stakeholders to have a clear understanding of the product's provenance, manufacturing process, and associated attributes.

In step 455, a tracking symbol in alignment with blockchain technology is generated. It's noteworthy that these tracking symbols can be established at various junctures along the value chain. Importantly, each tracking symbol is exclusively employed to trace the journey of a goods or commodity or a recycle materials to upstream of the tracking symbol issuing point. This practice enables the tracking of the product's origin and progression to the previous stage in the value chain from where the tracking symbol was initially issued.

In step 460, a distributor or buyer undertakes the registration of the associated digital asset linked to the procurement of a physical asset within a private wallet. Similar to the processes of the source and producer, distributors and buyers have the ability to transfer digital assets in tandem with physical assets. However, it's important to note that they do not possess the capability to initiate the creation of new digital assets.

To mitigate the risk of any unscrupulous transactions, it is imperative that each digital asset code or serial number corresponds precisely to its respective digital asset token ID. This ensures a secure transfer of physical assets in conjunction with digital assets.

By the aforementioned steps, the goods and transactions from the sellers and the buyers can be tracked in the supply chain by implementing the technique of the blockchain. The sellers will know where their goods go to and the buyer will understand where those goods come from. And for security reasons, a third party may understand there is a transaction happening between some of the issuers and some of the receivers, but the third party may not know the detail of the transaction, such as the cost of the goods and so on.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to determine and assess the reasonably fair scope of the present invention as pertains to any apparatus not materially departing from but outside the literal scope of the invention as set forth in the following claims.

1. A computer-implemented method for managing digital assets across a supply chain, the method comprising:
a) creating a first digital asset, the first digital asset comprising a first set of information;
b) tracking a first transaction on the supply chain, the first transaction being configured to use the first digital asset as input and comprising a first transaction information;
c) creating a second digital asset as output of the first transaction, the second digital asset comprising a second set of information; and
d) updating the second digital asset, the updating comprising:
aggregating the first set of information, the first transaction information and the second set of information; and
establishing a data relationship between the first digital asset, the first transaction and the second digital asset for tracing purposes,
wherein the first digital asset is associated to a physical first commodity across the supply chain,
wherein the first transaction is associated to a first tangible transformation process of the first commodity,
wherein the second digital asset is associated to a physical second commodity obtained from the physical first commodity when subjected to the first tangible transformation process, and
wherein each of the steps a), b), c) and d) are carried out on a blockchain framework.

2. The computer-implemented method according to claim 1, wherein updating the second digital asset further comprises:
changing ownership from a first owner of the first digital asset to a second owner of the second digital asset.

3. The computer-implemented method according to claim 1, wherein the first digital asset is a source digital asset associated to a source commodity, such as mineral ore, and the first set of information comprises information on origin and specification of the source commodity.

4. The computer-implemented method according to claim 1, wherein the first transaction is associated to a first tangible process, such as mineral processing, and the first transaction information comprises information on the first tangible process parameters and/or specifications.

5. The computer-implemented method according to claim 1, wherein the second digital asset is a product-type digital asset associated to a product commodity, such as a metal, and the second set of information comprises information on product specification.

6. The computer-implemented method according to claim 1, the method further comprising:
e) tracking a second transaction on the supply chain, the second transaction being configured to use the second digital asset as input and comprising a second transaction information;
f) creating a third digital asset as output of the second transaction, the third digital asset comprising a third set of information; and
g) updating the third digital asset, the updating comprising:
aggregating the first set of information, the first transaction information, the second set of information, the second transaction information and the third set of information; and
establishing a data relationship between the first digital asset, the first transaction, the second digital asset, the second transaction, and the third digital asset for tracing purposes,
wherein the second transaction is associated to a second tangible transformation process of the second commodity,
wherein the third digital asset is associated to a physical third commodity obtained from the physical second commodity when subjected to the second tangible transformation process, and
wherein each of the steps e), f) and g) are carried out on the blockchain framework.

7. The computer-implemented method according to claim 6, wherein the third digital asset further comprises:
changing ownership from the second owner of the second digital asset to a third owner of the third digital asset.

8. The computer-implemented method according to claim 6, wherein the second transaction is associated to a second tangible process, such as packaging and/or distribution, and the second transaction information comprises information on the second tangible process parameters and/or specifications such as packaging specifications.

9. The computer-implemented method according to claim 6, wherein the third digital asset is associated to a packaged or distributable commodity, such as a metal slab, and the third set of information comprises information on specifications of the packaged or distributable commodity.

10. The computer-implemented method according to claim 1, wherein the first digital asset is a plurality of first digital assets, each of the plurality of first digital assets being associated to a respective source commodity.

11. The computer-implemented method according to claim 1, wherein the second digital asset is a plurality of second digital assets, each of the plurality of second digital assets being associated to a respective product commodity.

12. The computer-implemented method according to claim 1, wherein the third digital asset is a plurality of third digital assets, each of the plurality of third digital assets being associated to a respective packaged or distributable commodity.

13. The computer-implemented method according to claim 6, wherein the first set of information, the second set of information and the third set of information satisfy at least one of mass and energy balance criteria over the supply chain such that losses over the first and the second tangible transformation process are considered in the at least one of mass and energy balance criteria.

14. The computer computer-implemented method according to claim 1, wherein the blockchain framework is Hyperledger fabric.

15. The computer computer-implemented method according to claim 6, wherein digital assets from same commodities are fungible.

16. The computer computer-implemented method according to claim 6, wherein digital assets are created based on authority protocols.
